(19) United States
(12) Patent Application Publication
(10) Pub. No.: US 2021/0335104 A1
(43) Pub. Date: Oct. 28, 2021

(54) SMART SHOPPING DEVICE AND SYSTEM

(71) Applicant: Cornerstone Automation Systems, LLC, Frisco, TX (US)

(72) Inventors: Tom Karol, Frisco, TX (US); Richard Steele, Frisco, TX (US); Maxwell Amaro, Pea Ridge, AR (US); Darian Carr, Frisco, TX (US); Kevin Nguyen, Frisco, TX (US); Ryan Bradford, Frisco, TX (US); Jorge Noyola, Frisco, TX (US); Gustavo Orellana, Frisco, TX (US); Hamed Sedeghi, Frisco, TX (US)

(21) Appl. No.: 17/243,332

(22) Filed: Apr. 28, 2021

Related U.S. Application Data
(60) Provisional application No. 63/016,802, filed on Apr. 28, 2020.

(51) Int. Cl. G07G 1/00; G06Q 20/20; B62B 3/14; B62B 5/00; H04W 4/80

(52) U.S. Cl. CPC G07G 1/0072; G06Q 20/208; H04W 4/80; B62B 3/1424; B62B 5/0096; G06Q 20/203

(57) ABSTRACT

Provided herein are aspects of a shopping device and system. In one embodiment, a shopping device includes a weight measurement device configured to weigh products placed thereon; a product interface configured to receive product identifiers; and a controller configured to communicate with a remote database and determine that a product identifier received by the product interface corresponds to a first product placed on the weight measurement device, determine a cost of the first product placed on the weight measurement device, and calculate a cumulative weight and cumulative cost of the first product with one or more products placed on the weight measurement device. Embodiments of a shopping system may also include a product carrying device and a user interface, wherein the user interface may include a visual display, an input interface, and a payment interface.

### CROSS-REFERENCE TO RELATED APPLICATION

This application claims the benefit of U.S. Provisional Application Ser. No. 63/016,802, filed by Tom Karol, et al. on Apr. 28, 2020, entitled “PRODUCE DISPLAY AND SMART SHELVING SYSTEM,” commonly assigned with this application and incorporated herein by reference in its entirety.

### BACKGROUND

Retailors generally inventory perishable products and fresh produce by visually inspecting the products for availability and expiration date. In some inventory methods for fresh produce, store associates may manually remove and weigh the produce from each bin. Not only does this process require labor and time for each produce display, but the accuracy of the inventory data depends on the associate's ability to follow outlined procedures.

In addition to inventory inspection, customers may desire a more streamlined in-store shopping process and touchless checkout. Further, for retailers that provide a touchless pickup option, associates need to be able to verify they are selecting the correct products for order fulfillment. What is needed is an inventory management system which may provide data driven inventory control, improve customer shopping experience, help streamline the supply chain, reduce inventory cost, and reduce labor.

### BRIEF DESCRIPTION OF THE DRAWING

Reference is now made to the following descriptions taken in conjunction with the accompanying drawings, in which:

FIGS. 1A and 1B illustrates one embodiment of a smart shopping device designed and manufactured according to one or more embodiments of the disclosure;

FIG. 2 is a system overview of another embodiment of a shopping device designed and manufactured according to one or more embodiments of the disclosure;

FIG. 3A illustrates one embodiment of a load cell feature with may be used with embodiments of a shopping device designed and manufactured according to one or more embodiments of the disclosure;

FIG. 3B is schematic of an embodiment of the load cell feature shown in FIG. 3A;

FIG. 4 illustrates one aspect of a user interface which may be used with embodiments of a shopping system designed and manufactured according to one or more embodiments of the disclosure;

FIG. 5 illustrates another aspect of the user interface which may be used with embodiments of a shopping system designed and manufactured according to one or more embodiments of the disclosure;

FIG. 6 illustrates one embodiment of a produce stand designed and manufactured according to one or more embodiments of the disclosure; and

FIG. 7 illustrates another embodiment of a produce stand having a smart shelf system designed and manufactured according to one or more embodiments of the disclosure.

### DETAILED DESCRIPTION

In the retail industry, products may generally be sold either as packaged (a pre-packaged bag or carton) or unpackaged goods. In the case of packaged produce, tracking and managing inventory levels may be considerably easier, since the packaging bag or carton is generally provided with a bar code, which may be associated with a package weight or unit quantity. Loosely sold produce may be sold by weight or quantity and may provide a more convenient option for consumers—they may select certain produce individually rather than a pre-packaged bag or carton. While loose produce may be more convenient for consumers, accurately tracking and maintaining inventory of loose produce may be more difficult for retail or wholesale providers. Traditionally, retailers have relied on visual inspection and manual counting methods to track loose produce inventory, which is known to be inaccurate. These methods are labor intensive and their accuracy may vary on the experience levels of the personnel. Produce may have a limited shelf life and thus, improper inventory management may lead to wastage and financial losses.

For packaged and/or non-perishable goods, it may be difficult for retailers to keep an up-to-date inventory as products are taken off the shelves by customers. In addition, customers may desire a more streamlined, touchless shopping process whereby the customer does not need to go through a traditional check out process. While self-checkout stations have become available in most retail locations, customers may still need to scan each item and transfer the items to a checkout station or location. Further, when there a surge of customers may be in the store, there may not be enough self-checkout stations and/or personnel to handle the amount of customers.

Weight measurements may be an important and effective way to track and manage inventory in industries. Weight measurements may also be able provide a better perishable and produce inventory management process, whereby as the customer places the products into their product carrying device, such as, i.e., a cart or handheld shopping basket or tote, the retailer's inventory management system knows that a customer has removed product from the shelf or display. For example, once fresh produce has been placed on a produce display stand on the retail floor, it may be challenging to weigh the produce. What is needed is a shopping device and produce display system configured to provide a more accurate count of the produce inventory than traditional display systems and inventory counting systems. Disclosed herein are embodiments of shopping devices and product display stands, such as smart shopping carts and smart shelf systems which may provide a system and method for weighing and tracking inventory in traditional produce display bins and shelves and inventory turnover as product is removed from the shelves by customers. For produce inventory, updating traditional produce display bins may include a weight and data-based inventory management system. Embodiments of a smart carts and smart shelf systems, in some embodiments, provided as a retrofit kit, disclosed herein, may be easily replace or be easily and simply installed into traditional product carrying devices (such as shopping carts and hand-held baskets and totes) and display bins with little to no impact on regular operations. Once installed, the smart carts and/or shelf system will operate independent of inputs from a store associate, which may lead to potential labor cost savings. Dynamic data points created by periodic load measurements from the smart shelf system and up-to-date inventory and weight measurements from the smart carts may provide valuable insight into customer buying patterns. Retailers may thus be able to better plan inventory cycles more accurately, thereby also benefitting the end customer by providing better quality produce at a better, more economical price. Accordingly, benefits of the present disclosure may include a more sustainable retail eco system where the retailer and end customer create a symbiotic relationship.

Embodiments of a smart cart shopping device and system and a smart shelf system presented in the disclosure may be constructed using metals, and may be enclosed and locked in place inside a housing or frame of a standard produce display. A smart shopping device and smart shopping system may be provided, in some embodiments, as complete smart shopping carts, handheld product carrying devices, and in other embodiments may include kits to retrofit existing shopping carts and hand-held baskets and totes. In some embodiments, once enclosed in a produce display stand, the smart shelf system may generally be hidden from view.

Aspects of the smart shopping devices and features of a smart shelf system may include a weight measurement device. The weight measurement device may include one or more load cells, which may measure weight of products placed thereon. In some embodiments, the physical deflection of the weight may be proportional to the voltage signal produced by them. The analog voltage signal may be converted by an analog to digital (ATD) module into a readable digital signal. Once product is loaded onto the weight measurement devices, the load cells measure the weight of the produce to within ±1 lb. The digital weight signal may then be transmitted to a wireless digital output device.

Embodiments disclosed herein may provide a continuous and or periodic recording of weight data, which over time may provide dynamic data points from a Product Sell Cycle. This data may be used for accurate data driven inventory control, streamlining of the supply chain, reduced inventory cost, and reduced wastage cost. The data may also provide valuable insight into consumer buying pattern as a function of time.

A smart cart or smart shopping device may be equipped with weight measurement, data recording and display capability. The weight measurement device, such as a scale, may include a plurality of load cells for weighing loads carried by the scale, an Analog to Digital (ATD) to convert analog voltage signal (weight) from the load cells into a digital readable signal, a microcontroller (with built-in amplifier) to transmit the digital signal from ATD to a controller. The smart cart may also include output or user interface device, such as a touch screen visual display, which may be mounted on a product carrying device, such as a shopping cart or handheld basket.

The user interface or output device may provide an interface between the scale and customer, wherein an application may be pre-installed on the user interface, such that products need to be scanned before being placed into the cart. The application may have a built-in database with weight information of products. When a product is scanned the application may calibrate/compare the weight of the scanned product versus a product weight in the database. The weight measurement may also serve to verify that the product scanned is the one that is placed on the smart cart, for loss prevention purposes. If a product is placed in the smart cart without being scanned, the software application may notify the customer to remove the item from cart.

The data recording feature may also provide data for a retailer to better predict product flow, and thus improve supply chain management. The weight measurement device may also be used purely as a produce weighing scale, wherein a customer may lookup the type of produce, and the smart cart can reconcile the total product cost based on the product weight.

In some embodiments, the smart cart may be equipped with a Point of Sale (POS) transaction or payment interface unit (such as credit card reader) to allow the customer to complete the monetary transaction. Future embodiments may include a customer interface wherein the customer may be able to login to an existing account with payment options already setup. Once the customer has completed all desired products into the smart cart, they can checkout/logout to complete the transaction.

In some embodiments, a product carrying device (shopping cart or basket) and/or a produce display bin may be retrofitted with a shopping device or smart shelf system disclosed herein. Embodiments of the smart shelf system may include weight measuring, data recording and display capability. The smart shopping systems may include a weight measurement device, which may include one or more load cells for weighing loads carried by the produce display, an Analog to Digital (ATD) module to convert the analog voltage signal from the load cells into the digital readable signal, and a microcontroller to transmit the digital signal from ATD. The microcontroller or microprocessor may be fitted with a short-range communication module, such as, e.g., a BLUETOOTH® module, through which the output signal with recorded weight may be displayed to host computing systems, which may include a portable handheld device, such as, e.g., a tablet computer, a smart phone, computing pad, desk top computer, server digital display device, or another type of computing device.

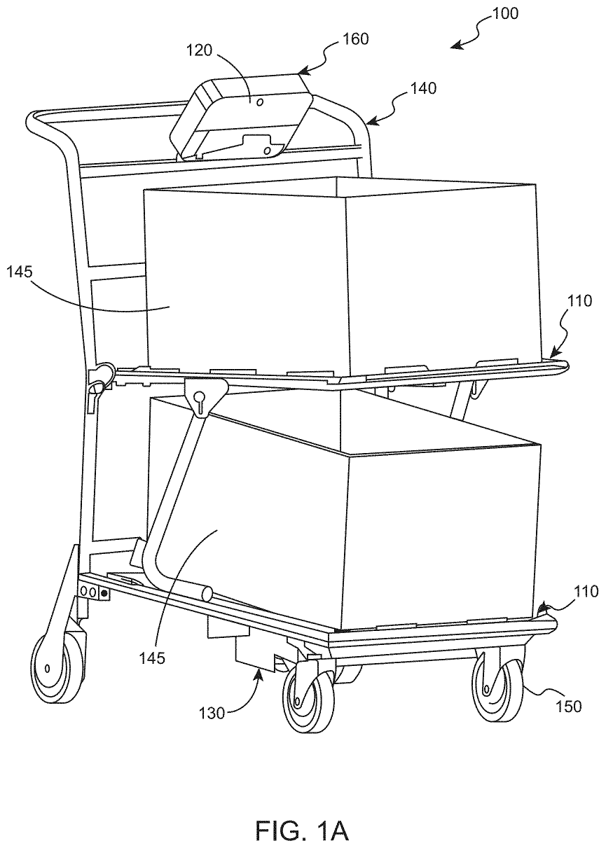

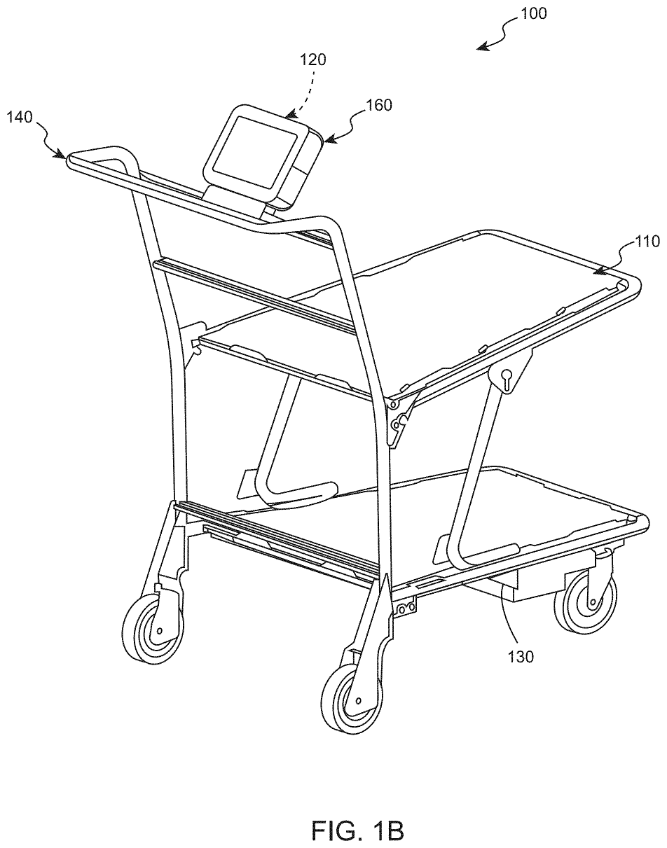

Referring now to FIGS. 1A-1B, there is shown an embodiment of a shopping device 100 (a “smart cart”) designed and manufactured according to aspects of the disclosure. The shopping device 100 may include a weight measurement device 110 configured to weigh products placed thereon. A product interface, scanner 120 may be configured to receive product identifiers. A controller 130, in some embodiments, may be configured to communicate with a remote database and determine that a product identifier received by the scanner 120 corresponds to a first product placed on the weight measurement device 110. The controller 130 may then determine a cost of the first product placed on the weight measurement device 110 and calculate a cumulative weight and cumulative cost of the first product with one or more products placed on the weight measurement device 110. In some embodiments, the shopping device may be incorporated onto a product carrying device 140, which in some embodiments, may be similar to traditional shopping carts having at least one receptacle 145 and wheels 150 positioned on the bottom. In some embodiments, the weight measurement device 110 may be positioned within or below the at least one receptacle 145 and include two or more load cells (not shown in FIG. 1A) configured to measure the weight of products placed on the weight measurement device 110. The two or more load cells may, in some embodiments, be coupled beneath the receptacle 145, or placed along or around a perimeter thereof. The controller 130, in this embodiment, is shown coupled onto the product carrying device 140. Although the controller 130 is shown in this embodiment near a bottom of the product carrying device 140, the controller 130 may be mounted in any number of locations, including adjacent the weight measurement device 110.

In this embodiment, the scanner 120 may be coupled with the product carrying device 140 near, or incorporated into a user interface 160. The scanner 120 may be a scanner such as a 1-dimensional scanner, such as e.g. Datalogic DSM0422-WA or similar scanners. The scanner 120, in other embodiments may be a 1-dimensional or 2-dimensional laser scanner, and in other embodiments may be an image based scanner.

The user interface 160 may, in some embodiments, include a visual display, an input interface such as, e.g. a keypad or similar input device, and in some embodiments may include a payment processing interface. The user interface 160 may in some embodiments be similar to touchscreen displays and user interfaces used in various retail locations for self-checkout stations and kiosks. In some embodiments, the user interface 160 may be configured to communicate with and receive inputs from a customer's mobile device.

FIG. 1B illustrates the shopping device 100 without the receptacles 145 installed thereon.

A customer shopping in a retail store may use the shopping device to collect and purchase products without any employee or customer service personnel. For example, the customer may select a fresh produce, such as, e.g., bananas to purchase. The customer will scan the bananas using the scanner 120 and place the bananas onto the weight measurement device 110, in this embodiment into the receptacle 145. For items such as produce, the controller 130 may calculate the cost of the produce based on the weight. The customer may then skip the step of weighing the produce before putting it into the receptacle 145. The controller 130 receives data from the weight management device 110 and the scanner 120 and determines, according to data received by a remote computing database, such as a store inventory management system, whether the item scanned by the scanner 120 matches with the weight of the bananas registered by the weight measurement device 110. As each additional item is scanned and placed into the receptacle 145 in the same way, the controller 130 may keep a cumulative weight price for the items scanned. When the customer has gathered all of their desired items, the customer may then use the user interface 160 to complete the purchase. In some embodiments, the customer may review the list of items scanned and their prices and the cumulative total. The user interface 160, in some embodiments, may include a payment interface wherein the customer may input a payment method, including, but not limited to a credit card reader or similar device. In some embodiments, the user interface may also communicate with the customer's mobile device to receive payment from payment applications, such as, e.g., VENMO®, APPLE PAY®, PAYPAL®, etc. and credit card payments.

The shopping device 100 may be sold as a complete smart cart or may be retrofitted onto existing product carrying devices such as shopping carts and hand held baskets.

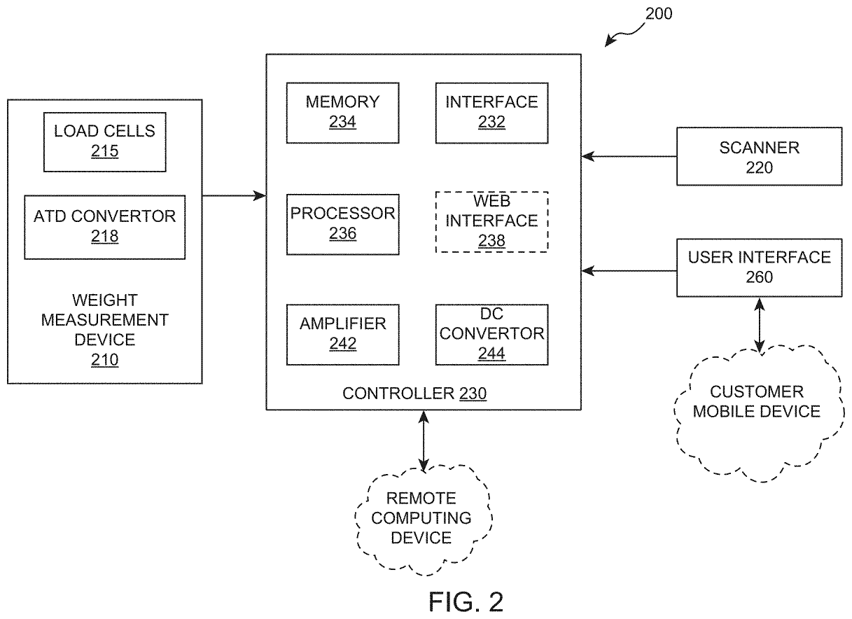

Referring now to FIG. 2, there is shown a system diagram of one embodiment of a shopping device 200. The weight measurement device 210 may in some embodiments, include two or more load cells 215. The weight measurement device 210 may also include an analog to digital (ATD) module 218 for converting analog readings by the two or more load cells 215 into a digital signal for controller 230. The controller 230 may include at least an interface 232 for communicating with other components of the shopping device 200. The interface 232 may include a wired interface, a wireless interface, or a combination thereof. A wired interface may be configured for communicating with components of the shopping device 200 such as a scanner 220, user interface 240, and the weight measurement device 210. A wireless communications interface may communicate with “remote” components of the shopping device 200 and also for such as a remote computing device, including but not limited to, e.g. a store inventory database or computing system, payment processing systems, etc. In some embodiments, the controller 230 may also include a memory 234. The memory 234 may store software and algorithms which may be executed by a processor 236. The controller 230, may in some embodiments, include a web interface 238. In some embodiments, the controller 230 may include an amplifier 242, for amplifying a signal from the interface 232 as needed. In certain embodiments, the controller may also include a power conversion circuit, such as a DC converter 244.

The user interface 240 may include a visual display and may, in some embodiments, include a touch screen device. The touch screen device may allow a customer to input and view data and in some embodiments, may interact with the customer's mobile device to receive data and payment processing information. For example, a customer may upload a shopping list and the user interface may keep track of items according to the shopping list, and in some embodiments, may provide a store location for each device.

In one example, the processor 236 may perform at least the following steps during a transaction of the shopping device 200.

Step 1: Receive product input from the scanner 220;

Step 2: Receive weight from the weight measurement device 210;

Step 3: Compare the weight with the product input;

Step 4: Cumulate the total weight and cost for the product data received; Repeat steps 1 through 4 for each product placed into the shopping device;

Step 5: Determine if the customer has finished shopping; If no then repeat steps 1 through 4; If yes, proceed to next steps; and

Step 6: Provide a cumulative total to the customer; and

Step 7: Receive payment from the customer.

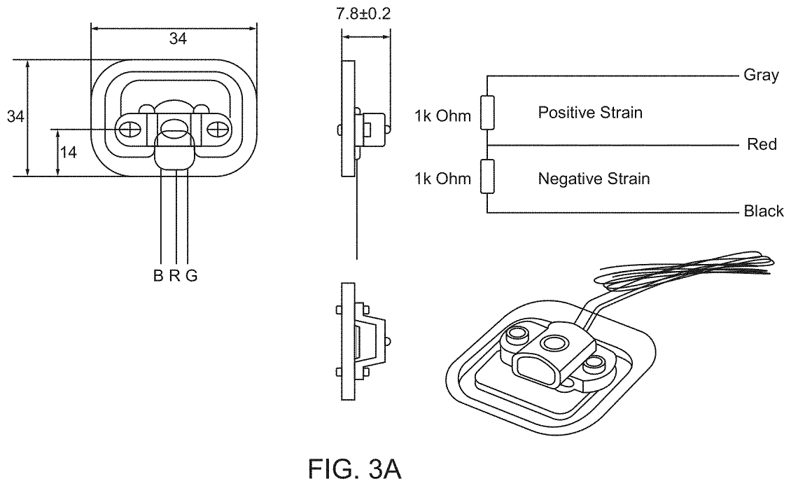

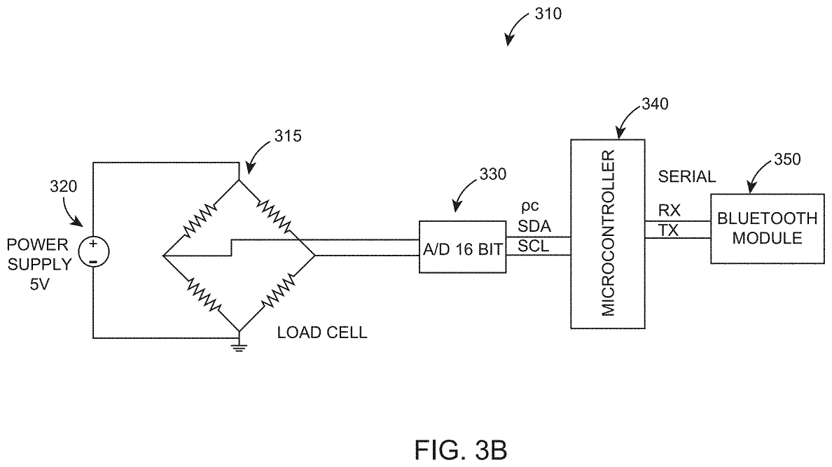

Referring now to FIG. 3A, there is shown one embodiment of a load cell 300 which may be used in embodiments of a smart shelf system, such as e.g. smart shelf system 800. In the embodiment shown, the load cell 300 is a load cell half bridge 50 KG which may be used in some embodiments. This load cell half bridge 50 KG sensor is one embodiment of a load cell which may provide better accuracy for electronic weighing devices than other available load cells. The load cell 300 may have a cantilevered E-shaped fork that undergoes a physical bending when a load is applied to it. The deflection of the E-shaped fork causes a potential difference change across the half bridge setup. The variation in potential difference is directly proportional to the weight on the load cell 300. Different load cell capacities may be used. For example, in the embodiment shown, four 50 KG load cells are used, which may handle a weight capacity of about 200 kg (440 lb.), but in other embodiments, the weight capacity may be increased. In another embodiment, the load cells 300 may be at least 5000 lb (2267.962 KG) load cells.

In some embodiments, the weight measurement apparatus/scale may record weight and log time changes to additions and subtractions to the product carrying device. The recorded weight and time may allow for a more accurate measurement of an amount of time product has been on sale or display than traditional inventory tracking. The recorded weight and time may also provide inventory tracking of a time the product may be used and/or replenished. The weight measurement apparatus/scale may, in other embodiments, verifies, according to the recorded weight and comparison with information in a retailer's inventory database, that the item placed thereon is the correct or incorrect item. In some embodiments, the item verification may be used to determine an amount to charge the customer for the item placed onto the scale. In other embodiments, the measurement apparatus/scale may record the weight of an item and calculate the cost based on reconciliation with the correct or incorrect item in the database thereby serving as a produce scale for grocery produce items to allow for a more accurate checkout of selected produce items.

Referring now to FIG. 3B, there is an example schematic for one embodiment of a load cell which may be used in a weight measurement device 310 for a smart shopping device and smart shelf system disclosed herein and for a load cell, such as e.g. a half bridge load cell circuit 315, which may include a power supply 320. In one embodiment, an analog voltage signal from load cells is input to an Analog to Digital (ATD) converter 330, which may then communicate a digital load signal to a microcontroller 340. A short-range communication module 350, such as a short-range (BLUETOOTH®) module, may either be built into the microcontroller 340 or it may be a stand-alone module wired into the circuit. The short-range communication module 350 may enable the weight data taken by the weight measurement device to be transmitted to a digital recording and output device and to a controller, such as controller 130. The data may be transmitted, in some embodiments, continuously, and in other embodiments may only be transmitted intermittently. In some embodiments, the data may be transmitted in time intervals, which may be programmed into the microcontroller 340 according to the needs of the customer.

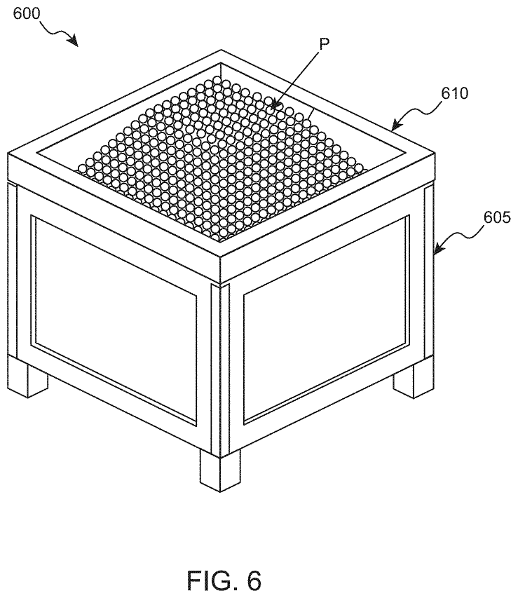

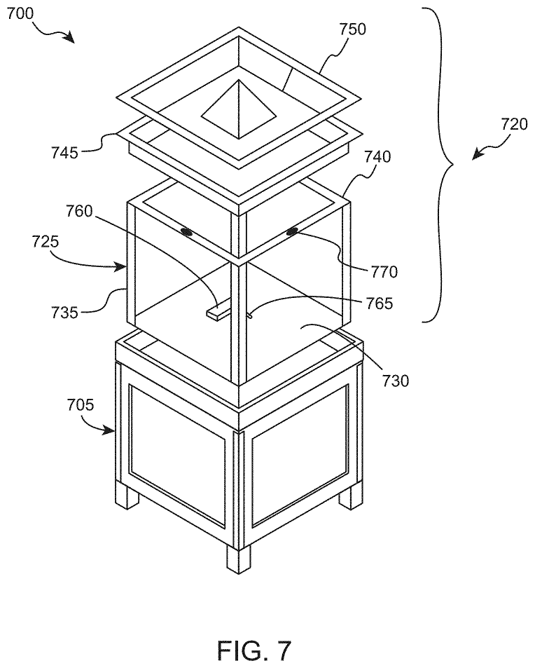

In some embodiments, such as where the shopping device may be implemented into a produce display or as a smart produce display such as the display stands shown in FIGS. 6 and 7, the weight data may be sampled in various time intervals. For example, in one embodiment, the weight data may be sampled every 5 seconds. In other embodiments, the weight data may be sampled every 10 seconds. In some embodiments where multiple smart shelves may be connected with each other, 100 in some embodiments, the time interval may be 1 minute, so after 1 minute the weight on 100 shelves may be updated. Samples may also rotate, such that a certain set or amount of display bins, such as 25 bins, may be taken at one time, then another 25, etc. Each of the different shelves or bins may be identified with their particular weights.

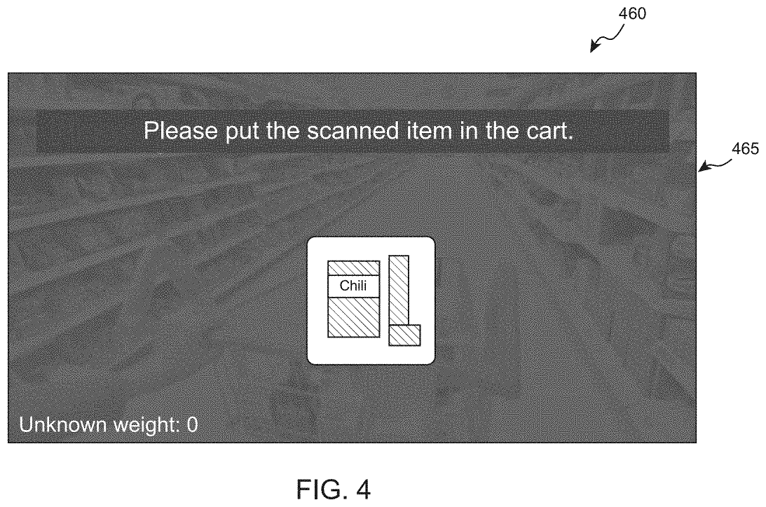

Referring now to FIG. 4, there is shown an embodiment of a user interface 460 which may be used with embodiments shopping devices and shopping systems disclosed herein. The user interface 460 may include a visual display 465 which may provide various types of information to the customer. The information which may be displayed to the customer may include, but not limited to, the following examples: product scanned, price, current product total, list of items in the cart, various instructions, such as, e.g., “place the item in the cart”, and many more instructions options which may be determine and customized by the retailer providing the shopping device.

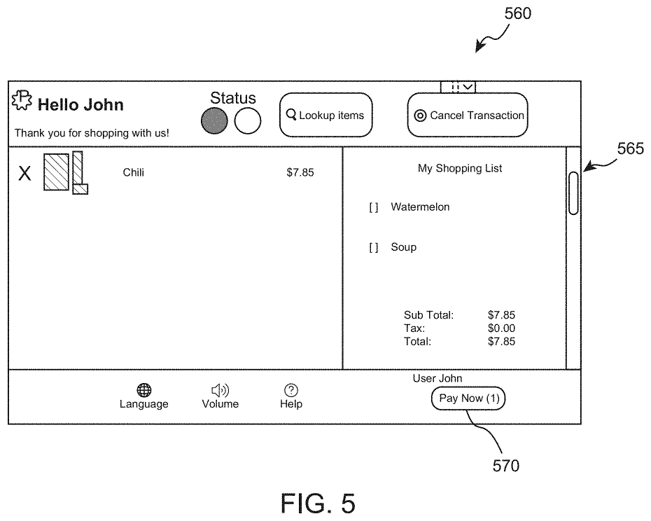

Referring now to FIG. 5, there is shown another example of data which may displayed on a visual display 565 of a user interface 560. The user interface 560 may also include a point of sale (POS) or payment interface to complete a purchase as shown on a payment indicator 570 of the visual display. In some embodiments, the user interface 560 may include a payment reader such as a credit card reader, and may, in other embodiments, be able to receive data from a user's mobile communication device.

Referring now to FIG. 6, there is shown a standard or typical produce display stand 600 which may be used with embodiments of a smart shelf system and embodiments of a smart shopping device, such as shopping device 100, according to the disclosure. The stand 600 includes a housing 605, which may be constructed using wood, plastic or metals Positioned at an upper end of the housing 605 is shown at least one produce display bin 610. The produce display bin 610 may be constructed from various materials, such as, e.g., high density plastic which enables the bin 610 to be formed to fit into an upper end of the frame of the housing 605. The display bin 610 may be filled with fresh produce P for display and retrieval by customers. Some stands 600 may include several display bins 610 and some stores may group several stands together to create a produce display island on the floor of the store.

Referring now to FIG. 7, there is shown another embodiment of a produce stand 700 including one embodiment of a smart shelf system 720 according to the disclosure. The produce stand 700 includes a housing 705, which may be constructed using wood, plastic or metals. The smart shelf system 720 may include, in some embodiments, a frame 725, the frame 725 including a base 730, support members 735 extending from the base 730, and an upper end 740 supported on the support members 735. The upper end 740, in this embodiment, is open for receiving one or more display bins therein, such as first display bin 745 and second display bin 750, which in some embodiments, are configured for receiving and displaying produce. In this embodiment, the second display bin 750 may be positioned in or above at least a portion of the first display bin 745, but in other embodiments, may include support members for positioning above at least a portion of the first display bin 745, and in some embodiments, may nest inside of the first display bin 745. Several display bins can also be located adjacent each other within the upper end 740. In some embodiments, the smart shelf system 720 is a retrofit kit which may be placed inside the housing 705.

The smart shelf system 720 may include a control system which may include at least a power supply 760 and a microprocessor 765 positioned on or near the base 730. In some embodiments, the microprocessor 765 includes or is coupled to a short-range data transmissions module, such as e.g., a BLUETOOTH® module or a Wireless Fidelity (WiFi) module. The power supply 760, in some embodiments, may be a portable and/or rechargeable power supply. Positioned about the upper end 740 may be one or more load cells 770. In some embodiments, there may be a weight measurement device which may include at least two load cells, and in some embodiments may include at least four load cells on each of four sides of the upper end 740, and in some embodiments, there may even more load cells according to the shape, size, and configuration of the produce display stand in which the smart shelf system 720 is placed and the number of display bins placed therein. The load cells 770, in some embodiments, may be positioned or cradled in overload protection brackets. In some embodiments, each load cell 770 may be connected, e.g. by wires one or a wireless short-range connection, with an Analog-To-digital (ATD) converter (not shown in FIG. 7) which may be wired to the microprocessor 765.

The smart shelf system 720, in this embodiment, is configured as a subassembly which is placed into the produce bin housing 705. When the first and second display bins 745 and 750 are placed on the upper end 740, each of the first and second display bins 745 and 750 may rest on at least one of the load cells 770. The load cells 770 may then determine and record the weight of the first and second display bins 745 and 750. One or more of the load cells 770 can be designated for specific display bins, such as first and second display bins 745 and 750. The recorded weight for each of the first and second display bins 745 and 750 is transmitted by the short-range transmissions module associated with the microprocessor 765 to a short-range communication enabled host system of the retailer where the produce stand 700 is placed, which in some embodiments, may be a hand-held display unit. The communication and electronic components of the smart shelf system 720 are powered by the power supply 760.

In some embodiments, when enclosed in the produce bin housing 705, the smart shelf system 720 may be completely concealed and hidden from consumers such that the produce bin 700 may look similar or the same as a typical produce display stand, such as produce display stand 600. However, the produce display bin 700 with the smart shelf system 720 may provide continuous and/or periodic records of weight of the bins, such as the first and second bins 745 and 750 of the produce stand 700, thereby providing weight of produce placed therein and therefore continuous and/or periodic amount of inventory and therefore providing inventory sales data, which may be valuable to retailers and produce suppliers.

In some embodiments, weight data from the weight measurement device may be sampled in various time intervals. For example, in one embodiment, the weight data may be sampled every 5 seconds. In other embodiments, the weight data may be sampled every 10 seconds. In some embodiments where multiple smart shelves may be connected with each other, 100 in some embodiments, the time interval may be 1 minute, so after 1 minute the weight on 100 shelves may be updated. Samples may also rotate, such that a certain set or amount of display bins, such as 25 bins, may be taken at one time, then another 25, etc. Each of the different shelves or bins may be identified with their particular weights.

Although the smart shelf system and produce displays are shown in the drawings in a generally rectangular shape, the smart shelf system may be constructed in various shapes, sizes, and configurations to accommodate various shapes, sizes, and configurations of produce displays, such as angled displays, refrigerated displays, tiered shelving, and various other shapes and configurations of produce displays.

Embodiments of the smart shelf system (retrofit kit) disclosed herein may be made in different sizes to fit different versions of the bins. In a retail store where multiple such produce bins are grouped together to create a produce island, a single power source may be used to power multiple retrofitted bins. Also, the data recording system on separate bins may be connected on the same network to input data into a single software portal to provide a consolidated data set for the end user. A controller or processor can be configured to receive the data from the smart shelf system via an interface and process the received data to determine inventory. The processing can be directed by a series of operating instructions stored on a non-transitory computer readable medium. A memory or data storage associated with the processor can store the instructions that correspond to algorithms for processing the weights or other data from the smart shelf system and providing an output, such as inventory, time windows of purchase, estimate of number of times produce is handled, automatic reordering of produce (or other product on smart shelf system), etc.

For example, the produce stand periodically transmits weight data of the product on the produce display stand to the recording software. The drop in weight of the recorded weight data over time may be interpreted as the product sold over a known period of time. Assuming that the weight of each piece of produce in a batch is virtually the same, the number of pieces sold in a known time period may be determined with a certain degree of accuracy. By statistically analyzing the recorded weight data, a reliable data curve may be developed to determine the selling trends and demand as a function of time for each individual product. This may enable retailers to introduce lean methods such as FIFO (First-In-First-Out) to reduce wastage and financial losses. Overall, the supply chain may be optimized to meet the retailer's goal of selling fresh produce to the customer at a reasonable price, making profit at the same time.

A portion of the above-described devices, systems or methods may be embodied in or performed by various analog or digital data processors, wherein the processors are programmed or store executable programs of sequences of software instructions to perform one or more of the steps of the methods. A processor may be, for example, a programmable logic device such as a programmable array logic (PAL), a generic array logic (GAL), a field programmable gate arrays (FPGA), or another type of computer processing device (CPD). The software instructions of such programs may represent algorithms and be encoded in machine-executable form on non-transitory digital data storage media, e.g., magnetic or optical disks, random-access memory (RAM), magnetic hard disks, flash memories, and/or read-only memory (ROM), to enable various types of digital data processors or computers to perform one, multiple or all of the steps of one or more of the above-described methods, or functions, systems or apparatuses described herein.

Portions of disclosed examples or embodiments may relate to computer storage products with a non-transitory computer-readable medium that have program code thereon for performing various computer-implemented operations that embody a part of an apparatus, device or carry out the steps of a method set forth herein. Non-transitory used herein refers to all computer-readable media except for transitory, propagating signals. Examples of non-transitory computer-readable media include, but are not limited to: magnetic media such as hard disks, floppy disks, and magnetic tape; optical media such as CD-ROM disks; magneto-optical media such as floppy disks; and hardware devices that are specially configured to store and execute program code, such as ROM and RAM devices. Examples of program code include both machine code, such as produced by a compiler, and files containing higher level code that may be executed by the computer using an interpreter.

Aspects of the disclosure may include the following:

Aspect A: A shopping device, comprising a weight measurement device configured to weigh products placed thereon; a product interface configured to receive product identifiers; and a controller configured to communicate with a remote database and determine that a product identifier received by the product interface corresponds to a first product placed on the weight measurement device, determine a cost of the first product placed on the weight measurement device, and calculate a cumulative weight and cumulative cost of the first product with one or more products placed on the weight measurement device.

Aspect B: A shopping system comprising a product carrying device for receiving a plurality of products therein; a weight measurement device positioned within the product carrying device configured to weigh products placed thereon; a product interface configured to receive product identifiers; and a controller configured to communicate with a remote database and determine that a product identifier received by the product interface corresponds to a first product placed on the weight measurement device, determine a cost of the first product placed on the weight measurement device, and calculate a cumulative weight and cumulative cost of the first product with one or more products placed in the product carrying device.

Aspect C: A method of providing a shopping service, the method comprising: providing a shopping device the shopping device including a product carrying device for receiving a plurality of products therein, a weight measurement device positioned within the product carrying device configured to weigh products placed thereon, a product interface configured to receive product identifiers, and a controller configured to communicate with a remote database and determine that a product identifier received by the product interface corresponds to a first product placed on the weight measurement device, determine a cost of the first product placed on the weight measurement device, and calculate a cumulative weight and cumulative cost of the first product with one or more products placed in the product carrying device; and providing a user interface configured to receive inputs from the shopping device and a customer using the shopping device.

Aspects A, B, and C may have one or more of the following additional elements in combination: Element 1: wherein the weight measurement device includes two or more load cells; Element 2: wherein each of the two or more load cells is at least a 50 KG capacity load cell; Element 3: wherein each of the two or more load cells is at least a 500 lb. capacity load cell; Element 4: wherein the controller includes a communications module; Element 5: wherein the communications module is a short-range communication module; Element 6: wherein the short-range communications module is a BLUETOOTH® module or a Wi-Fi module; Element 7: wherein the controller includes an analog-to-digital (ATD) converter; Element 8: wherein the product interface is a scanner; Element 9: wherein the shopping system includes a user interface; Element 10: wherein the user interface includes a visual display and a customer input interface; Element 11: wherein the user interface is a touch screen interface; Element 12: wherein the user interface further includes a payment entry interface; Element 13: wherein the product carrying device is a shopping cart; Element 14: wherein the shopping cart includes wheels; Element 15: wherein the product carrying device is a portable shopping basket; and Element 16: wherein the weight management system includes at least one container coupled to the product carrying device.

Additional Aspects may include Aspect D: A shelf system for use with a produce display bin, the shelf system comprising a frame, the frame including a base, support members, and an upper end; two or more load cells positioned on and about the upper end; a display bin, the display bin engaging the two or more load cells; and a control system, the control system including a power supply, microprocessor for processing data from the two or more load sensors, and a communications module for communicating the processed data to a remote computing station.

Aspect E: A produce display bin, comprising a housing; and a smart shelf system positioned within the housing, the smart shelf system including a frame, the frame including a base, support members, and an upper end; two or more load cells positioned on and about the upper end; a display bin, the display bin engaging the two or more load cells; and a control system, the control system including a power supply, microprocessor for processing data from the two or more load sensors, and a communications module for communicating the processed data to a remote computing station.

Aspect F: A method for tracking inventory of produce, the method comprising providing a smart shelf system, the smart shelf system including a frame, the frame including a base, support members, and an upper end; two or more load cells positioned on and about the upper end; a display bin, the display bin engaging the two or more load cells; and a control system, the control system including a power supply, microprocessor for processing data from the two or more load sensors, and a communications module; placing the smart shelf system into a produce display stand, reading weight data, by the load cells, of the produce placed into the display bin, receiving at the microprocessor the weight data; analyzing the weight data; and communicating the analyzed weight data to a remote computing station.

Aspects D, E, and F may have one or more of the following additional elements in combination: Element 1: wherein the frame includes 4 load cells; Element 2: wherein each of the two or more load cells is at least a 50 KG capacity load cell; Element 3: wherein each of the two or more load cells is at least a 500 lb. capacity load cell; Element 4: wherein the communications module is a short-range communication module; Element 5: wherein the short-range communications module is a BLUETOOTH® module; Element 6: wherein the short-range communications module is a Wi-Fi module; Element 7: wherein the control system includes an analog-to-digital (ATD) converter; Element 8: wherein reading the weight data occurs at one or more time intervals; Element 9: wherein the one or more time intervals is at least every 5 seconds; and Element 10: wherein the one or more time intervals is at least every 10 seconds. Element 11: a processor configured to receive the weight data from multiple display bins and manage the inventory of the products of the multiple display bins based on the weight data. Element 12: wherein the processor is configured to automatically place orders for additional products based on the weight data.

Further additions, deletions, substitutions and modifications may be made to the described embodiments.

We claim:

1. A shopping device, comprising:
a weight measurement device configured to weigh products placed thereon;
a product interface configured to receive product identifiers; and
a controller configured to communicate with a remote database and determine that a product identifier received by the product interface corresponds to a first product placed on the weight measurement device, determine a cost of the first product placed on the weight measurement device, and calculate a cumulative weight and cumulative cost of the first product with one or more products placed on the weight measurement device.

2. The shopping device according to claim 1, wherein the weight measurement device includes two or more load cells.

3. The shopping device according to claim 2, wherein each of the two or more load cells is at least a 50 KG capacity load cell.

4. The shopping device according to claim 1, wherein the controller includes a wireless communications module.

5. The shopping device according to claim 4, wherein the wireless communications module is a short-range communications module.

6. The shopping device according to claim 1, wherein the remote database includes an inventory management database.

7. The shopping device according to claim 1, wherein the controller includes an analog-to-digital (ATD) converter.

8. The shopping device according to claim 1, wherein the product interface is a scanner.

9. A shopping system comprising:
a product carrying device for receiving a plurality of products therein;
a weight measurement device positioned within the product carrying device configured to weigh products placed thereon;
a product interface configured to receive product identifiers; and
a controller configured to communicate with a remote database and determine that a product identifier received by the product interface corresponds to a first product placed on the weight measurement device, determine a cost of the first product placed on the weight measurement device, and calculate a cumulative weight and cumulative cost of the first product with one or more products placed in the product carrying device.

10. The shopping system according to claim 9, wherein the weight measurement system includes two or more load cells.

11. The shopping system according to claim 10, wherein each of the two or more load cells is at least a 50 KG capacity load cell.

12. The shopping system according to claim 9, wherein the controller includes a wireless communications module.

13. The shopping system according to claim 9, wherein the controller includes an analog-to-digital (ATD) converter.

14. The shopping system according to claim 9, wherein the weight management system includes containers coupled to the product carrying device.

15. The shopping system according to claim 9, wherein the product carrying device is a shopping cart or a portable basket.

16. The shopping system according to claim 9, wherein the product interface is a scanner.

17. The shopping system according to claim 9, wherein the shopping system further includes a user interface.

18. The shopping system according to claim 17, wherein the user interface includes a visual display and an input interface.

19. The shopping system according to claim 17, wherein the user interface further includes a payment entry interface.
